(19) United States
(12) Patent Application Publication
(10) Pub. No.: US 2017/0323245 A1
(43) Pub. Date: Nov. 9, 2017

(54) STATUSES OF EXIT CRITERIA

(71) Applicant: HEWLETT PACKARD ENTERPRISE DEVELOPMENT LP, Houston, TX (US)

(72) Inventors: Ronen ASEO, Yehud (IL); Efrat MININBERG, Yehud (IL); Terry CAPONE HAVA, Yehud (IL)

(73) Assignee: HEWLETT PACKARD ENTERPRISE DEVELOPMENT LP, Houston, TX (US)

(21) Appl. No.: 15/527,547

(22) PCT Filed: Dec. 1, 2014
(86) PCT No.: PCT/US2014/067879

§ 371 Date: May 17, 2017

(51) Int. Cl. G06Q 10/06; G06N 5/02; G06N 99/00

(52) U.S. Cl. CPC G06Q 10/063114; G06Q 10/063118; G06N 5/022; G06N 99/005

(57) ABSTRACT

An example system in accordance with an aspect of the present disclosure includes at least one exit criteria assigned to a stage in a lifecycle of a project. A status of the at least one exit criteria is updated automatically in real-time corresponding to source information. The stage may be selectively prevented from advancing in the lifecycle based on the at least one exit criteria.

### BACKGROUND

It can be important for a team (e.g., in project management) and a project to align on criteria to be met to complete a task or process, e.g., in project methodologies such as Agile where the team is empowered with self-management abilities. Teams may have different perceptions regarding exit criteria for a process, and whether a feature of the process is complete/done. These differences may lead to chaos in project development, bad perceptions of organizational methodologies, and poor-quality products.

### BRIEF DESCRIPTION OF THE DRAWINGS/FIGURES

FIG. 1 is a block diagram of a system including a configuration engine, an update engine, and an enforcement engine according to an example.

FIG. 2 is a block diagram of a system including configuration instructions, update instructions, interface instructions, and enforcement instructions according to an example.

FIG. 3 is a block diagram of exit criteria and satisfaction levels according to an example.

FIG. 4 is a block diagram of exit criteria, status, and an overview according to an example.

FIG. 5 is a flow chart of an example process for assigning exit criteria to a stage, updating statuses of the exit criteria, and enforcing the exit criteria.

### DETAILED DESCRIPTION

Project management tools may be used to manage different stages of a task, over a lifecycle of the task. A stage of the lifecycle may be associated with exit criteria, which may be satisfied to allow the task to proceed from the current stage to the next stage of the lifecycle. Such criteria may be defined at a program level or team level. Prior to the present examples disclosed herein, project management tools may have had limited visibility for various exit criteria, and corresponding limited tracking and enforcement of processes to align with the exit criteria. For example, a quality assurance manager would have been needed, in prior examples, to manually perform checks on information, and manually decide whether to enforce various rules/progress after the fact (i.e., not checked in real time).

In contrast, examples described herein provide the ability to configure clear exit criteria definitions, with customized threshold settings, for a development lifecycle stage, enabling teams to easily track development and improve product development velocity and quality. These criteria are visible to the team, their progress is tracked and reported to stakeholders, and the criteria can be set to be enforced. Thus, teams and team members may easily align to the exit criteria, with a clear understanding of the status of the project. Status is easily ascertainable as to, not only the progress of items being developed, but also as to the real progress towards the stage of an item being defined as “done” in view of the exit criteria. For example, the exit criteria to determine whether a stage of a product backlog item is complete, may be referred to herein as a “definition of done” (DoD).

Further, examples may provide a real-time updated indication of a status of the exit criteria that are defined for a stage, which may be used to enforce exit criteria guidelines for whether a stage may progress to a next stage in a project lifecycle. Thus, an item/stage may be prevented from moving to the next development lifecycle stage, unless the defined and enforced exit criteria guidelines have been met. Accordingly, the examples described herein enable teams and managers to track and enforce the best practices using clear methodology across teams for a program/project, facilitating ease of scaling up (e.g., from a team-level to an enterprise level). Examples also may use machine learning on gathered information, to identify trends that can be utilized in combination with various information sources to provide recommendations to teams regarding optimal settings for development lifecycle exit criteria. Such trends and recommendations may minimize and/or avoid post-release defects and/or regressions, due to providing information/recommendations to teams for making smarter decisions on development focus, identification of bottlenecks, which features are in release condition, and which features are currently in need of further attention (e.g., backlog items). Such information may be obtained and/or generated automatically, and is not limited to textual or manually defined information.

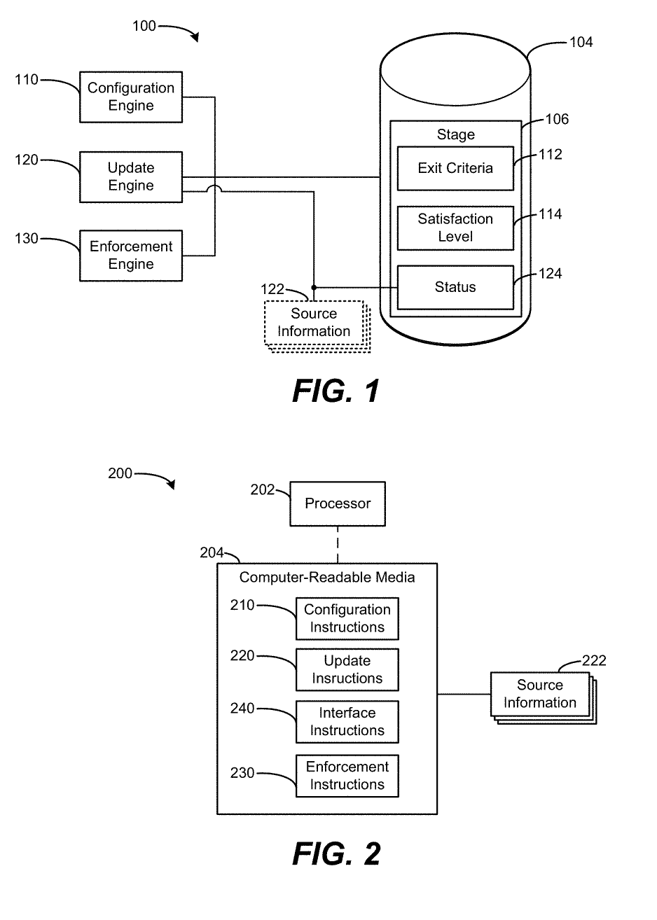

FIG. 1 is a block diagram of a system 100 including a configuration engine 110, an update engine 120, and an enforcement engine 130 according to an example. System 100 is to interact with source information 122 and storage 104. Storage 104 includes a stage 106. The stage 106 is associated with an exit criteria 112, a satisfaction level 114, and a status 124. As used herein, a stage may be assigned exit criteria, and may refer to a process or backlog item, such as a stage in a user story or a feature of a tool such as Agile management.

The configuration engine 110 may perform functions related to assigning at least one exit criteria 112 and/or satisfaction level 114 to a stage 106 in a lifecycle of a project, and other configuration functionality. The update engine 120 may identify source information 122, and update the status 124 of the exit criteria 112 according to the source information 122. The update engine 120 may perform functionality automatically in real-time, e.g., without a need for user intervention and according to when the source information 122 updates. The enforcement engine 130 may prevent the stage 106 from advancing in the lifecycle, unless the exit criteria 112 is/are satisfied.

Storage 104 may be accessible by the system 100, to serve as a computer-readable repository to store information such as stage 106, exit criteria 112, satisfaction level 114, and status 124 that may be referenced by the engines 110, 120, 130 during operation of the engines 110, 120, 130. As described herein, the term “engine” may include electronic circuitry for implementing functionality consistent with disclosed examples. For example, engines 110, 120, and 130 represent combinations of hardware devices (e.g., processor and/or memory) and programming to implement the functionality consistent with disclosed implementations. In examples, the programming for the engines may be processor-executable instructions stored on a non-transitory machine-readable storage media, and the hardware for the engines may include a processing resource to execute those instructions. An example system (e.g., a computing device), such as system 100, may include and/or receive the tangible non-transitory computer-readable media storing the set of computer-readable instructions. As used herein, the processor/processing resource may include one or a plurality of processors, such as in a parallel processing system, to execute the processor-executable instructions. The memory can include memory addressable by the processor for execution of computer-readable instructions. The computer-readable media can include volatile and/or non-volatile memory such as a random access memory (“RAM”), magnetic memory such as a hard disk, floppy disk, and/or tape memory, a solid state drive (“SSD”), flash memory, phase change memory, and so on.

In some examples, the functionality of engines 110, 120, 130 may correspond to operations performed in response to, e.g., information from storage 104, user interaction as received by the, e.g., configuration engine 110, and so on. The storage 104 may be accessible by the system 100 as a computer-readable storage media, in which to store items in a format that may be accessible by the engines 110, 120, 130.

Examples described herein may be operable with various tools, including those relating to Agile and scaled Agile frameworks to best practice Agile at scale, and products for application lifecycle management and quality center performance insight, performance testing, cost project reports, and so on. For example, iterative and incremental development frameworks for managing product development, and/or knowledge work management with just-in-time delivery where the process, from definition of a task to its delivery to the customer, may be displayed for participants to see and team members pull work from a queue.

In examples, Agile backlog development lifecycle flow may include stages, such as planning, development, and testing phases. These stages are customizable to adhere to a lifecycle. Examples described herein fit within and align with such frameworks, e.g., achieving quality in Agile and other related approaches. Examples may be applied, e.g., to a backlog type of item, whether a user story in Agile that is managed at a team and sprint level, or a feature that is managed within a scope of a products release. Such benefits may be achieved based on the customizable exit criteria 112, satisfaction level 114, and status 124 of stages 106 according to the examples described herein. System 100 may use such exit criteria 112 as rules under which a stage 106 (e.g., of a backlog item) may advance to a next stage in a lifecycle flow. Examples may be applied, e.g., in Agile at scale, providing a clear exit criteria and “Definition of Done,” thereby ensuring that multiple teams can have access to the same exit criteria 112 to enable quality targets to be met at a program level.

The status 124 of the exit criteria 112 may be updated by the system 100 in real-time, and guidelines of the exit criteria 112 may be enforced so that items may be prevented from moving to the next development lifecycle phase (e.g., unless the defined exit criteria 112 guidelines are met for that stage 106).

Examples described herein may use custom exit criteria 112, and also may use out-of-the-box (e.g., OOTB “preset example”) Definition of Done settings. The OOTB configurable DoD settings may be customized to various methodology and/or frameworks, and may be, e.g., aligned with the Scaled Agile Framework (SAFe) for DoD. For example, OOTB DoD settings may include: whether acceptance criteria is met, whether unit tests coded have passed, whether coding standards are followed, whether code has been peer-reviewed, whether code is checked-in and merged into mainline, whether story acceptance tests are written and/or passed (automated where practical), whether there are no remaining must-fix defects, and whether a story is accepted by the product owner. These are merely some examples of exit criteria 112, and various other customized exit criteria 112 may be used, including criteria manually entered by a user or automatically identified by system 100 (e.g., by analysis of previously collected/identified data or source information 122).

System 100 may automatically check the status 124 for the exit criteria 112 based on the source information 122, and may update the status 124 in real-time. For example, the system 100 may identify which source information 122 corresponds to the exit criteria 112, check the corresponding source information 122, and update the status 124 (e.g., relative to the satisfaction level 114) as the source information 122 itself changes. Thus, examples may leverage assets and interconnections of source information 122 from various testing tools, to bring visibility on how well a stage 106 aligns with agile practices for quality and the status 124 of the exit criteria 112. The source information 122 may be fetched automatically from various sources, enable information to be obtained without a need to set up a manual checklist, and so on. Source information 122 may be obtained from tools (such as a tool used to identify defect coverage and so on) that are already in use, and the source information 122 automatically may be presented and enforced according to the status 124 of the exit criteria 112. For example, the automatically obtained source information 122 may be presented in terms of, e.g., how well the stage 106 is proceeding according to a percentage of alignment with the exit criteria 112 as defined for the stage 106. In alternate examples, other data presentations besides numerical percentages may be used, such as line graphs, pie charts, text, and so on to illustrate the status 124.

The source information 122 may provide various data to be collected by system 100, which may come from multiple sources. For example, source information 122 may be sourced from information that is entered manually by an end user, and/or information that the system 100 automatically obtains from test automation services, build servers, other tools, and so on. Examples may pull source information 122 from external sources such as build servers, software configuration management (SCM) sources, test automation servers, and so on. Regardless of the specifics on the source information 122, the exit criteria 112 and status thresholds (e.g., satisfaction levels 114) may be fully configured/customized manually.

For example, an exit criteria 112 may correspond to whether a working state of the project code has been approved by a user. Such an example exit criteria 112 corresponds to a yes/no status 124, and the system 100 may consider sources such as feedback from the user tasked to give approval, and/or a system log tracking whether the user has given approval. Another example exit criteria 112 may be whether automated tests for a given stage 106 have been performed. This type of source information 122 may automatically be gathered from various sources (e.g., plugins etc.), which the system 100 may hook into without a need for user intervention. Accordingly, the system 100 may perform real-time analysis and checking, based on real-time data available to the system 100. A given exit criteria 112 may use source information 122 from a plurality of different sources.

The status 124 of a stage 106 may be tracked/updated in real-time. For example, the source information 122 may be constantly monitored and the status 124 may correspondingly be constantly updated. The type of real-time and/or automatic updating may be defined in terms of the type of source information 122 being monitored. For example, the latest information regarding one type of source information 122 may periodically update, according to the sources connected to the system 100. Thus, the status 124 may be updated in real-time, and may change periodically along with the periodic changes to that type of source information 122. Alternatively, the source information 122 may update constantly and/or irregularly, with the status 124 being similarly updated in real-time to track such updating of the source information 122. Accordingly, the status 124 may be updated and current, such that at any point in time, the status 124 may be checked to identify whether the exit criteria 112 for the stage 106 are satisfied (e.g., relative to the satisfaction level(s) 114).

The system 100 may check the source information 122, and/or update the status 124, based on polling (e.g., at intervals), based on interrupts (e.g., where a change to the source information 122 immediately triggers a check and corresponding update to the status 124), or other approaches. Such real-time approaches to updates may be based on a type of the sources connected to the system 100, and how frequently the sources may report corresponding data/source information 122. For example, source information 122 relating to open defects in a code may be updated as soon as a defect in the code is closed (e.g., by a user closing the defect) or a step otherwise being completed. In contrast, source information 122 relating to information from an agent may update in response to the agent being invoked when a test is run, whereby such information would be available the next time the test is run. Various types of sources correspondingly have varied availability of updated source information 122, which may be collected/monitored in real-time by example system 100. The source information 122 may be checked automatically, in view of the system 100 being capable of automatically calculating/recalculating the status 124. Accordingly, the system 100 does not need manual intervention in order to update the status 124 and check the exit criteria 112. Such updating may similarly be performed according to the nature of the type of sources from which source information 122 is obtained.

The system 100 may interact with and/or integrate with various tools compatible with obtaining the source information 122. For example, a tool may obtain application lifecycle intelligence (ALI) to identify patterns in application development, such as information regarding code coverage. Tools for obtaining information also may include testing tools, code coverage tools, code validation tools, and so on. These and other tools may automatically check various sources, and automatically generate the source information 122 and corresponding status 124 for exit criteria 112 that check for such information. Tools may obtain information from build servers, source controller servers, and various other sources of information (e.g., sources used to obtain test data information).

Various sources may report different data/source information 122 that may be used in evaluating status 124 of exit criteria 112 (e.g., test coverage, code coverage, test pass rate, automation rate, etc.). Such sources may be obtained based on automated agents deployed on servers with access to such data, including static code analytics tools. Such tools may enable the system 100 to identify trends in how to work, best practices, what criteria should be used to track a project, and so on, e.g., based on configured reports, functionalities, and other customizations appropriate for system 100 and source information 122 that is to be obtained for evaluation of status 124 and other features of the stage 106. Example systems 100 may provide features that are tightly coupled with recommended Agile processes (e.g., OOB DoDs), guiding users through setting up of exit criteria 112 and satisfaction level(s) 114, and updating the status 124. Example systems 100 may hook in other reports/sources of information to be included as part of an exit criteria 112 to be evaluated.

Accordingly, example systems 100 may test for a Definition of Done (DoD), e.g., based on on or more exit criteria 112. The exit criteria 112 for a given stage 106 may be built and defined, and checked for their status 124 by fetching or checking source information 122 from various sources, to enforce whether the stage 106 may proceed in the lifecycle.

FIG. 2 is a block diagram of a system 200 including configuration instructions 210, update instructions 220, interface instructions 240, and enforcement instructions 230 according to an example. The computer-readable media 204 includes the instructions 210-240, and is associated with a processor 202 and source information 222. The interface instructions 240 may be used to set up a screen display/resolution of a computing system, and otherwise enable the display of content and user interface features such as informational windows with which a user may interact to configure exit criteria and satisfaction levels, including arranging user interface elements such as selectable steps, user prompts, and visual layout. The interface instructions 240 may correspond to an interface engine (not specifically shown in FIG. 1) that may be included in the computing system 100 of FIG. 1. The computing system 200 of FIG. 2 may also include a processor 202 and computer-readable media 204, associated with the instructions 210, 220, 230, 240, and which may interface with the source information 222. In some examples, operations performed when instructions 210-240 are executed by processor 202 may correspond to the functionality of engines 110-130 (and an interface engine as set forth above, not specifically illustrated in FIG. 1). In FIG. 2, the operations performed when instructions 210 are executed by processor 202 may correspond to functionality of configuration engine 110 (FIG. 1). Similarly, the operations performed when update instructions 220 and enforcement instructions 230 are executed by processor 202 may correspond, respectively to functionality of update engine 120 and enforcement engine 130 (FIG. 1). Operations performed when interface instructions 240 are executed by processor 202 may correspond to functionality of an interface engine (not specifically shown in FIG. 1).

As set forth above with respect to FIG. 1, engines 110, 120, 130 may include combinations of hardware and programming. Such components may be implemented in a number of fashions. For example, the programming may be processor-executable instructions stored on tangible, non-transitory computer-readable media 204 and the hardware may include processor 202 for executing those instructions 210, 220, 230. Processor 202 may, for example, include one or multiple processors. Such multiple processors may be integrated in a single device or distributed across devices. Media 204 may store program instructions, that when executed by processor 202, implement system 100 of FIG. 1. Media 204 may be integrated in the same device as processor 202, or it may be separate and accessible to that device and processor 202.

In some examples, program instructions can be part of an installation package that when installed can be executed by processor 202 to implement system 100. In this case, media 204 may be a portable media such as a CD, DVD, flash drive, or a memory maintained by a server from which the installation package can be downloaded and installed. In another example, the program instructions may be part of an application or applications already installed. Here, media 204 can include integrated memory such as a hard drive, solid state drive, or the like. While in FIG. 2, media 204 includes instructions 210-240, one or more instructions may be located remotely from media 204. Conversely, although FIG. 2 illustrates source information 222 located separate from media 204, the source information 222 may be included with media 204.

The computer-readable media 204 may provide volatile storage, e.g., random access memory for execution of instructions. The computer-readable media 204 also may provide non-volatile storage, e.g., hard disk or solid state disk for storage. Components of FIG. 2 may be stored in any type of computer-readable media, whether volatile or non-volatile. Content stored on media 204 may include images, text, executable files, scripts, or other content that may be used by examples as set forth below. For example, media 204 may contain configuration information or other information that may be used by engines 110-130 and/or instructions 210-240 to provide control or other information.

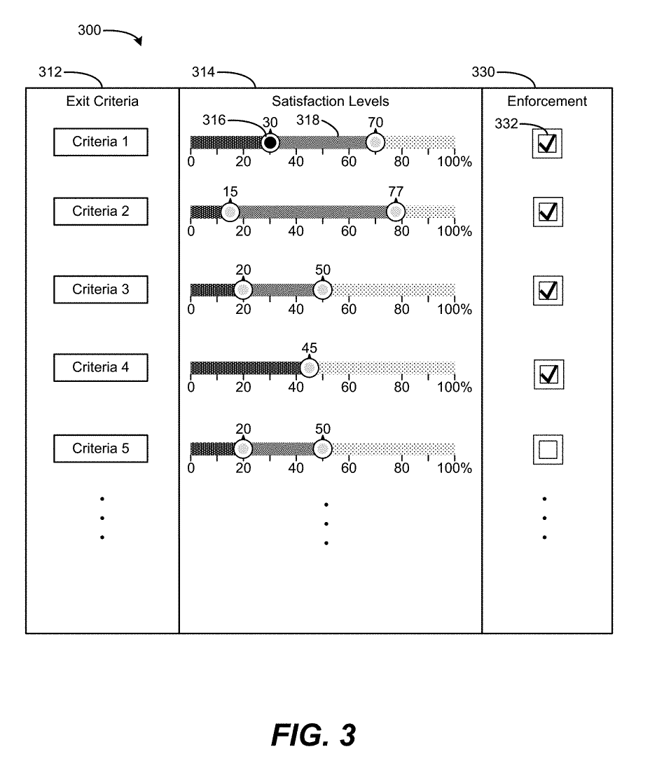

FIG. 3 is a block diagram of exit criteria 312 and satisfaction levels 314 according to an example. A plurality of exit criteria 312 are shown, corresponding to a plurality of satisfaction levels 314, for a given stage of a lifecycle. A satisfaction level 314 is associated with a slider 316 and status categories 318. FIG. 3 depicts an informational window 300, which may be generated in some examples as an interactive graphical user interface by interface instructions 240 (FIG. 2). The panels of the window 300 are not limited to being displayed together as shown, e.g., on the same screen, or as specifically illustrated in FIG. 3, and are provided as examples. The informational window 300 also includes an enforcement panel 330, including enforcement toggles 332 corresponding to the criteria 312.

The window 300 may be used to manage satisfaction levels 314 of exit criteria 312. For example, the window 300 may be accessed as a configuration setting of an Agile manager, e.g., in a workspace level. The exit criteria 312 may be used to define a definition of done for a given stage of a task in project management, e.g., for a workspace level such as in a feature definition of done, and a user story definition of done.

The window 300 demonstrates that an exit criteria 312 may have one or multiple satisfaction levels 314, as indicated by slider(s) 316. In an example, two sliders 316 may be used to designate two satisfaction levels for an exit criteria 312. Exit criteria 1 illustrates a first slider set to 30%, and a second slider set to 70%. In contrast, exit criteria 4 illustrates one slider 316 set to 45%. Thus, the satisfaction levels 314 may be specified as specific percentages corresponding to a development item that needs to be developed according to the exit criteria 312. FIG. 3 illustrates five example exit criteria 312, which may be out-of-the-box criteria, integrated from other tools, and/or custom defined.

The one or more sliders 316 may be used to set the status categories 318 (e.g., divisions) for an exit criteria 312. In some examples, the status categories 318 may be color coded, such as a red portion from 0% to the first slider, an orange portion between the first and second sliders, and a green portion between the second slider and 100%. Accordingly, for exit criteria 1, a status of less than 30% would result in a red (failed) status, 30-70% would result in orange (attention) status, and 70-100% would result in green (passed) status. Thus, each exit criteria 312 may be configured using the sliders 316 to establish customized satisfaction levels 314. Accordingly, when source information is checked and exit criteria status is updated, the status for a given exit criteria 312 can be categorized according to where progress falls within the customized satisfaction levels 314. The collection of exit criteria 312 may form a definition of done for a stage.

The features illustrated in FIG. 3 thus enable configuration of custom exit criteria 312, and corresponding definition of done settings, per stage/project. The exit criteria 312 may be manually specified, and also may be included in various examples as out-of-the-box (OOTB) features. Accordingly, a development stage may be specified by whether an exit criteria 312 is determined as part of the definition of done, and what are the accepted threshold(s) for the exit criteria 312 according to the satisfaction levels 314. The definition of done and exit criteria may be tracked based on users having clear visibility of progress toward meeting the definition of done settings, e.g., relative to the satisfaction levels 314 as set forth for the exit criteria 312. This visibility may be presented in various Agile viewpoints, such as in backlog item entity details, backlog item grids, and/or team Story board (e.g., information displayed on the backlog item cards). Agile is one example, and examples set forth herein are applicable to other types of tools/interfaces.

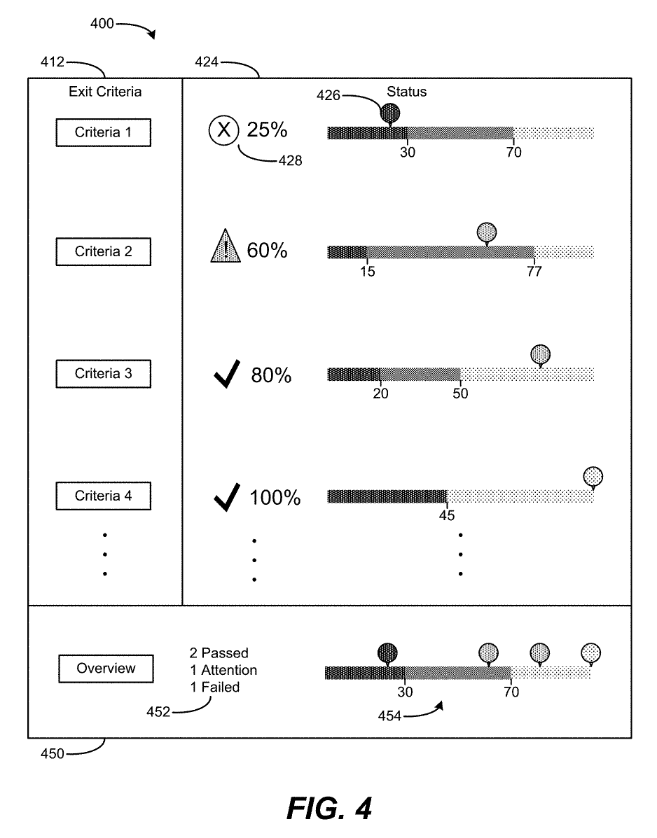

The definition of done and exit criteria 312 may be selectively enforced, e.g., by and enforcement engine 130 of FIG. 1. As shown in FIG. 3, the enforcement panel 330 includes an enforcement toggle 332 that may be associated with an exit criteria 312. Accordingly, the enforcement toggle 332 enables a choice of whether an exit criteria 312 is to be enforced as part of a definition of done for the corresponding stage, e.g., for an Agile feature, user story, project, etc. As illustrated in FIG. 3, exit criteria 1-4 are to be enforced, in contrast to exit criteria 5 that is not to be enforced (and therefore exit criteria 5 is not shown in FIG. 4). In some examples, if the exit criteria 312 is associated with being enforced according to enforcement toggle 332, then the item/stage corresponding to window 300 may be prevented from advancing to the next stage if it does not meet the various exit criteria 312. As illustrated in FIG. 3, the example stage may proceed even if exit criteria 5 is not satisfied, due to the lack of a checkbox in the enforcement toggle 332 for criteria 5.

An example stage, such as the window 300 of FIG. 3, may correspond to a user story or other unit of work for an agile project. A user story has a lifecycle of one or more stages throughout its development process. For example, a user story may begin in a new stage, with corresponding criteria that are to be satisfied before proceeding to a next stage (e.g., a preparation stage). Following stages may include a coding stage, a test stage, a done stage, and so on. A stage and its corresponding exit criteria 312 may selectively be enforced, such that the defined exit criteria 312 is checked for enforcement, and its various corresponding information sources may be evaluated. The status of an exit criteria 312 thus may be identified, determined, and visibly displayed (as shown, e.g., in FIG. 4) based on connecting to information sources for enforced exit criteria 312. If the statuses of exit criteria 312 are not fully aligned with the enforced satisfaction levels 314, example computing systems may identify how far the exit criteria may be from reaching the corresponding satisfaction levels 314.

In an example, if an attempt is made to move an item/stage from one state of a storyboard to another, but the enforced exit criteria 312 is not met, the computing system may display a relevant message explaining why, e.g., including the current status of alignment of statuses of the exit criteria 312 relative to the failure of statuses to satisfy the designated satisfaction levels 314.

As another example, a project may include four stages. A new stage, that is associated with a first exit criteria 312 of sizing an item, and a second exit criteria 312 of assigning the item to a team. If satisfied, the project may advance from the new stage to a preparation stage. The preparation stage may be associated with exit criteria 312 including spec review, feature lead identification, and acceptance criteria defined. These exit criteria 312 each may be associated with customized satisfaction levels. For example, a criteria may have one slider 316 (e.g., as shown with criteria 4 in FIG. 3) to indicate a pass/fail status. The next stage in this example project may be a coding phase associated with exit criteria 312 of whether 100% unit tests have passed, and whether 80% code coverage is reached. Thus, respective criteria satisfaction sliders may be set to 100% for unit tests, and 80% for code coverage. Next, a testing stage may be associated with exit criteria 312 of whether all acceptance tests are passed, whether there are no linked open defects, and whether there is 100% code coverage. Upon satisfaction of such exit criteria 312, the project may proceed to a done stage. Examples may include other criteria, such as whether acceptance criteria is met, whether all user stories are done, code coverage percent, test coverage percent, test pass rate percent, automation percent, number of critical and high severity open defects, and defect density percent.

Thus, an item may pass through several stages in its lifecycle before an item is done, which is fully configurable. For a stage, exit criteria 312 may be defined, e.g., in terms of what criteria is to be satisfied according to what satisfaction levels 314, which also may be customized. Whether the exit criteria 312 meets a given satisfaction level 314 may be identified by providing real-time data from source information, as to how the exit criteria 312 is aligned with the specified satisfaction levels 314, and whether the exit criteria 312 is enforced according to the enforcement toggles 332.

FIG. 4 is a block diagram of exit criteria 412, status 424, and an overview 450 according to an example. FIG. 4 depicts an informational window 400, which may be generated as an interactive graphical user interface by interface instructions 240 (FIG. 2). The panels of the window 400 are not limited to being displayed together, e.g., on the same screen, as specifically illustrated in FIG. 4, and may vary in other examples. The status 424 includes a status indicator 426 and a status icon 428. The overview 450 includes an overview summary 452 and a stacked status 454. The stacked status 454 may display cumulative results for some or all exit criteria 412, and the colored status categories for the stacked status 454 may be approximated in view of the various individual status categories of the various exit criteria 412.

Window 400 may be displayed as a tooltip pop-up window, e.g., in an Agile workspace or other management interface such as in a backlog item itself, and/or in the user story. An example tooltip of window 400 may pop up and describe the status of a stage/item according to the exit criteria as set out for the definition of done for the stage. Thus, examples may compare source information for a given exit criteria 412 and designated satisfaction levels, in order to establish a position for the status indicators 426. For example, the status 424 for criteria 1 is 25% done, which falls within a “failed” satisfaction level (e.g., as established by sliders for criteria 1 satisfaction levels as shown in FIG. 3). The status indicator 426 may be color coded according to the visual color of where the indicator 426 falls in the status categories of the satisfaction levels.

Thus, window 400 may concisely set forth visibility, at a glance, for the various exit criteria 412 for a stage, and display their levels of completeness using the status indicators 426. Graphical information may be augmented using status icons 428 and other information such as the summary information 452 and stacked status 454 contained in the overview 450. Thus, examples enable high visibility on how well a stage is progressing at various points of time, enabling predictability for quality and production delivery (and other various exit criteria 412 as specified).

Example computing systems may use machine learning and other approaches to identify trend estimates and recommend various satisfaction levels or other criteria. For example, a computing system may predict how much time feature development might take, in view of the DoD, the feature size (SP), the team velocity, and/or other similar historical features/data. The computing system thus may proactively provide an alerting if the feature estimation is inconsistent, and/or may generate other recommended features to be used (e.g., exit criteria, satisfaction levels, statuses, etc.). In another example, the computing system may automatically change the DoD exit criteria, based on production measurements and/or escalations on production release tickets that might accumulate to change the test coverage scale. Further, examples may automatically change the DoD criteria, based on other workspace DoD statuses and historical data.

In some examples, default values may be used. A default DoD may be used, e.g., for an entire workspace. Example computing systems may identify features that might need a different DoD scale, e.g., based on the attributes mentioned above. The computing system thus may automatically recommend to the user to change the DoD (i.e., exit criteria and/or satisfaction levels), according to the findings and/or potential trends in collected source information. Example computing systems may accumulate large volumes of code/data, for use with machine learning to provide targeted customer advice and recommendations and/or predictions without revealing specific details of the analyzed data. Thus, customers may identify what may be addressed in order to improve the work. Example computing systems may perform trend estimates and provide recommendations by utilizing previously stored code information to teach the machine (e.g., using machine learning) as to what may serve as optimal settings for various exit criteria. For example, a computing system may identify historical trends with certain exit criteria and/or specific workspaces/testing environments, eventually leading to recommendations for using or not using certain settings/exit criteria/satisfaction levels.

Thus, machine learning may be accumulated over time, based on hosted data of many customers on a given system, enabling an example computing system to learn from one customer and apply trends/recommendations to other customers. For example, the computing system may enhance a definition of done for a given stage of development having various factors in common, based on predictive analytics and big data available as source information to the computing system, without disclosing confidential information of specific customers.

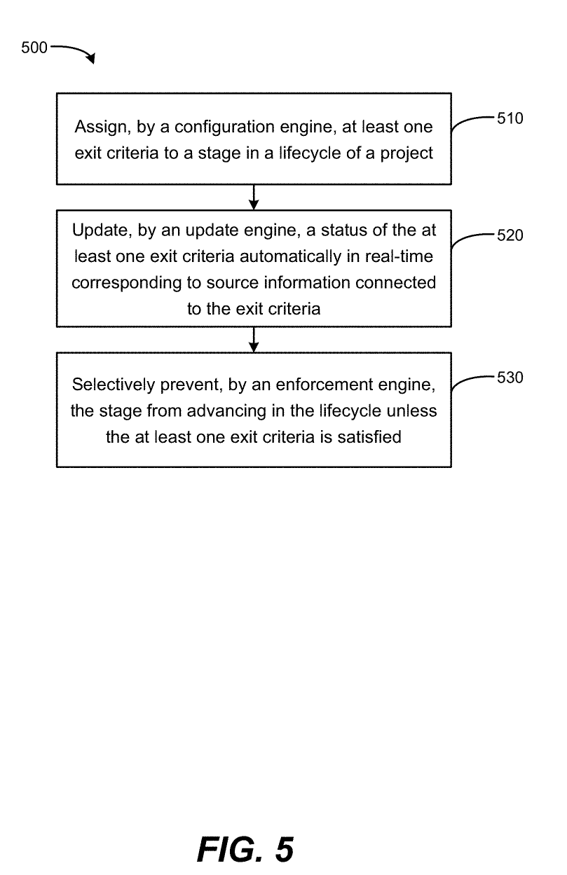

Referring to FIG. 5, a flow diagram is illustrated in accordance with various examples of the present disclosure. The flow diagram represents processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 5 is a flow chart 500 of an example process for assigning exit criteria to a stage, updating statuses of the exit criteria, and enforcing the exit criteria. In block 510, a configuration engine is to assign at least one exit criteria to a stage in a lifecycle of a project. For example, a first stage may be associated with reaching a code entry threshold as specified by satisfaction level sliders. In block 520, an update engine is to update a status of the at least one exit criteria automatically in real-time corresponding to source information connected to the exit criteria. For example, an analytic tool may run as an agent on a code entry server, to automatically check an amount of code entry and update the status relative to the established satisfaction level sliders. In block 530, an enforcement engine is to selectively prevent the stage from advancing in the lifecycle unless the at least one exit criteria is satisfied. For example, the exit criteria may include an enforcement toggle that is selected, causing the computing system to check whether the code entry threshold has been satisfied according to the status of the source information. If the threshold is met, then the project may proceed to the next stage of the project lifecycle.

Thus, examples described herein enable benefits including automatic measurement of Definition of Done and exit criteria, utilizing various sources of information without needing manual/human input. Example solutions may include out-of-the-box solutions compatible with Agile tools, without needing additional installation or configuration input from users. Solutions may be aligned with the latest principles in Enterprise Agile (such as the scaled agile framework), offering embedded methodology within the tool. Accordingly, program teams may easily track and identify problems/bottle necks in their development processes, using highly visible tracking. Example solutions may be expanded and configured to include data coming from static code analytics tools and other information sources, which may be automatically updated to enable real-time updating of the status of the exit criteria for stages in project lifecycles.

Examples provided herein may be implemented in hardware, programming, or a combination of both. Example systems can include a processor and memory resources for executing instructions stored in a tangible non-transitory computer-readable media (e.g., volatile memory, non-volatile memory, and/or computer-readable media). Non-transitory computer-readable media can be tangible and have computer-readable instructions stored thereon that are executable by a processor to implement examples according to the present disclosure. The term “engine” as used herein may include electronic circuitry for implementing functionality consistent with disclosed examples. For example, engines 110-130 of FIG. 1 may represent combinations of hardware devices and programming to implement the functionality consistent with disclosed implementations. In some examples, the functionality of engines may correspond to operations performed by user actions, such as selecting steps to be executed by processor 202 (described above with respect to FIG. 2).

What is claimed is:

1. A computing system comprising:
a configuration engine to assign at least one exit criteria to a stage in a lifecycle of a project, and to assign at least one satisfaction level to the at least one exit criteria;
an update engine to identify source information corresponding to the at least one exit criteria, and update a status of the at least one exit criteria automatically in real-time corresponding to the source information; and
an enforcement engine to selectively prevent the stage from advancing in the lifecycle unless the at least one exit criteria is satisfied.

2. The computing system of claim 1, further comprising an interface engine to graphically present the status of the at least one exit criteria relative to the at least one satisfaction level.

3. The computing system of claim 2, wherein the interface engine is to enable manual user manipulation of the at least one satisfaction level.

4. The computing system of claim 3, wherein the at least one satisfaction level is manipulable according to a graphical slider to designate a plurality of status categories displayed using a corresponding plurality of colors.

5. The computing system of claim 2, wherein the at least one exit criteria is associated with a corresponding manipulable at least one enforcement toggle, to selectively enable and disable enforcement of the at least one exit criteria by the enforcement engine.

6. The computing system of claim 2, wherein the interface engine is to graphically present the status based on a tooltip pop-up window.

7. The computing system of claim 1, wherein the configuration engine is to generate a trend estimate of a frequency of change of the source information, and generate at least one recommended satisfaction level for the at least one exit criteria based on the trend estimate, wherein the configuration engine is to update the trend estimate responsive to source information being collected.

8. The computing system of claim 7, wherein the configuration engine is to generate the trend estimate based on machine learning.

9. The computing system of claim 1, wherein the update engine is to update the status according to how frequently at least one connected source information is to update.

10. A method, comprising:
assigning, by a configuration engine, at least one exit criteria to a stage in a lifecycle of a project;
updating, by an update engine, a status of the at least one exit criteria automatically in real-time corresponding to source information connected to the exit criteria; and
selectively preventing, by an enforcement engine, the stage from advancing in the lifecycle unless the at least one exit criteria is satisfied.

11. The method of claim 11, further comprising assigning a plurality of satisfaction levels to a corresponding one of the at least one exit criteria, wherein the status is to indicate which satisfaction level is reached based on a color.

12. The method of claim 11, wherein the plurality of satisfaction levels are manually adjustable.

13. A non-transitory machine-readable storage medium encoded with instructions executable by a computing system that, when executed, cause the computing system to:
assign, by a configuration engine, at least one exit criteria to a stage in a lifecycle of a project;
assign, by the configuration engine, a plurality of satisfaction levels to the at least one exit criteria;
update, by the update engine, a status of the at least one exit criteria automatically in real-time, corresponding to source information that is to change over time; and
display, by an interface engine, the status of the at least one exit criteria relative to the at least one satisfaction level.

14. The storage medium of claim 13, further comprising instructions that cause the computing system to generate, by the configuration engine, a trend estimate of a frequency of change of the source information, and generate a time prediction corresponding to how long it will take to reach the plurality of satisfaction levels for the at least one exit criteria based on the trend estimate, wherein the configuration engine is to update the trend estimate responsive to source information being collected.

15. The storage medium of claim 14, further comprising instructions that cause the computing system to generate, by the interface engine, a recommendation to change the plurality of satisfaction levels, based on the trend estimate and the time prediction.
